(19) United States
(12) Patent Application Publication
(10) Pub. No.: US 2009/0033514 A1
(43) Pub. Date: Feb. 5, 2009

(54) REMOTE CONTROLLER

(76) Inventors: Tsutomu Yamagiwa, Osaka (JP); Naoki Tatehata, Kyoto (JP); Takaya Nakamura, Osaka (JP)

Correspondence Address: WENDEROTH, LIND & PONACK L.L.P., 2033 K. STREET, NW, SUITE 800, WASHINGTON, DC, 20006, US

(21) Appl. No.: 12/180,724

(22) Filed: Jul. 28, 2008

(30) Foreign Application Priority Data
Jul. 30, 2007 (JP) 2007-197090

(51) Int. Cl. G05B 19/10

(52) U.S. Cl. 340/825.22

(57) ABSTRACT

A remote controller includes a capacitive touch panel having flexibility, push switches beneath a lower surface of the capacitive touch panel, a control unit for detecting a position on an upper surface of the capacitive touch panel which is touched, and a transmitter for transmitting a first remote-control signal indicating the detected position and a second remote-control signal indicating the activating of the push switches. The remote controller is capable of remotely controlling various operations of an apparatus with a simple operation.

### FIELD OF THE INVENTION

The present invention relates to a remote controller for use in remotely controlling electronic apparatuses.

### BACKGROUND OF THE INVENTION

As electronic apparatuses, such as television receivers, video cassette recorders, and air conditioners, have been improved in functional performance, remote controllers for remotely controlling the apparatuses are required to control the apparatuses reliably in various operations.

FIG. 5 is a perspective view of a conventional remote controller 501 disclosed in Japanese Patent Laid-Open Publication No. 2006-33680. Push buttons 2 and a manipulator 3 having substantially a disk shape are provided on an upper surface of a case 1 having substantially a box shape and made of insulating resin material. An operator tilts the manipulator 3 to operate it.

Push switches having contacts electrically closing and opening in response to an operation to the push buttons 2 and the manipulator 3, a transmitter, such as a light emitting diode, and a control unit, such as a microcomputer, for allowing the transmitter to transmit a remote-control signal in response to the electrically closing and opening of the push switches, thus providing the remote controller 501.

Directing the remote controller 501 towards an electronic apparatus, such as a television receiver, the operator presses a predetermined button out of the push buttons 2 with a finger, thereby activating a push switch corresponding to the button electrically. This electrical activation causes the control unit to transmit a remote-control command signal of infrared ray form the transmitter to the electronic apparatus, thereby, for example, turning on and off the television receiver or increasing and decreasing a volume of sound.

While a display screen, such as a liquid crystal display, of the electronic apparatus displays options, such as broadcast programs, the operator presses down and tilting an upper end of the manipulator 3 with a finger, thereby electrically activating a push button beneath the upper end. This electrical activation allows the control unit to transmit a remote-control signal from the transmitter to the electronic apparatus, accordingly moving an indicator, such as a cursor, upward to one of the options on the display screen. The operator presses down and tilts a lower end, a left end, or a right end of the manipulator 3, a push switch is electrically activated. This electrical activation allows the control unit to move the indicator downward, leftward, or rightward to one of the options on the display screen.

In the operator may move the indicator excessively while tilting the manipulator 3 upward, downward, leftward, or rightward, through On occasion, the operator moves the indicator back in a reverse direction. In order to move the indicator back in the reverse direction, the operator removes the finger from the manipulator 3, confirms a place of the manipulator 3 to be pushed, and pressing down the place of the manipulator 3 once again to move the indicator in a desired direction, consequently complicating the operation to the remote controller and erroneously operating the remote controller.

### SUMMARY OF THE INVENTION

A remote controller includes a capacitive touch panel having flexibility, push switches beneath a lower surface of the capacitive touch panel, a control unit for detecting a position on an upper surface of the capacitive touch panel which is touched, and a transmitter for transmitting a first remote-control signal indicating the detected position and a second remote-control signal indicating the activating of the push switches.

The remote controller is capable of remotely controlling various operations of an apparatus with a simple operation.

### BRIEF DESCRIPTION OF THE DRAWINGS

FIG. 1 is a cross sectional view of a remote controller according to an exemplary embodiment of the present invention.

FIG. 2A is a perspective view of the remote controller according to the embodiment.

FIG. 2B is a schematic view of the remote controller and an apparatus according to the embodiment.

FIG. 3 is an exploded perspective view of a capacitive touch panel of the remote controller according to the embodiment.

FIGS. 4A and 4B illustrate display screens of the apparatus to be controlled with the remote controller according to the embodiment.

FIG. 5 is a perspective view of a conventional remote controller.

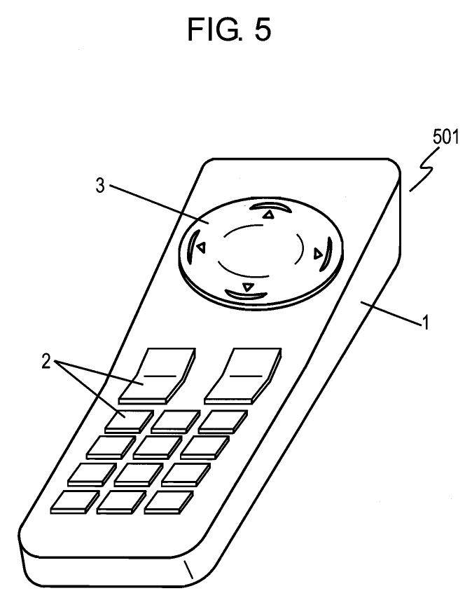

### DESCRIPTION OF THE PREFERRED EMBODIMENT

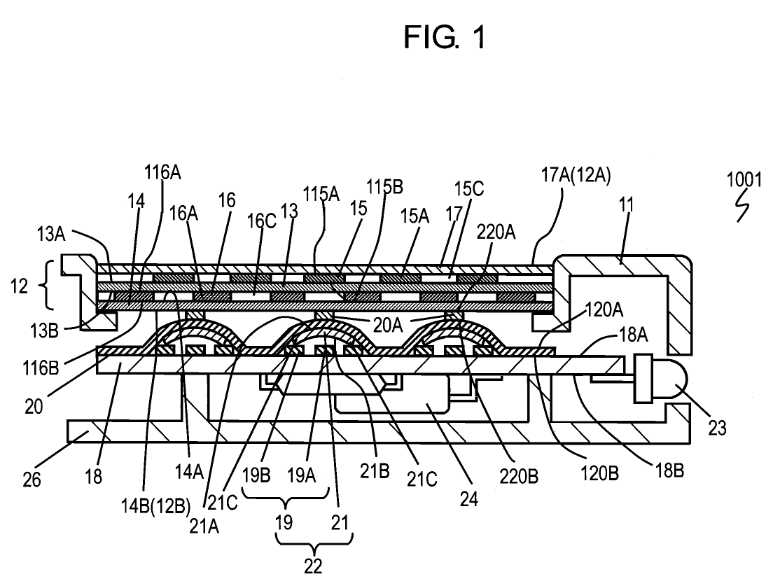

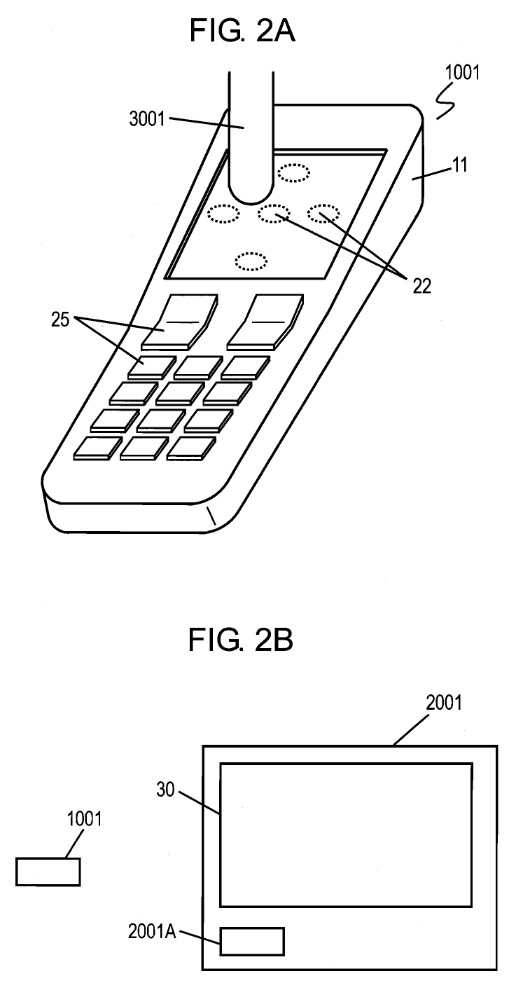

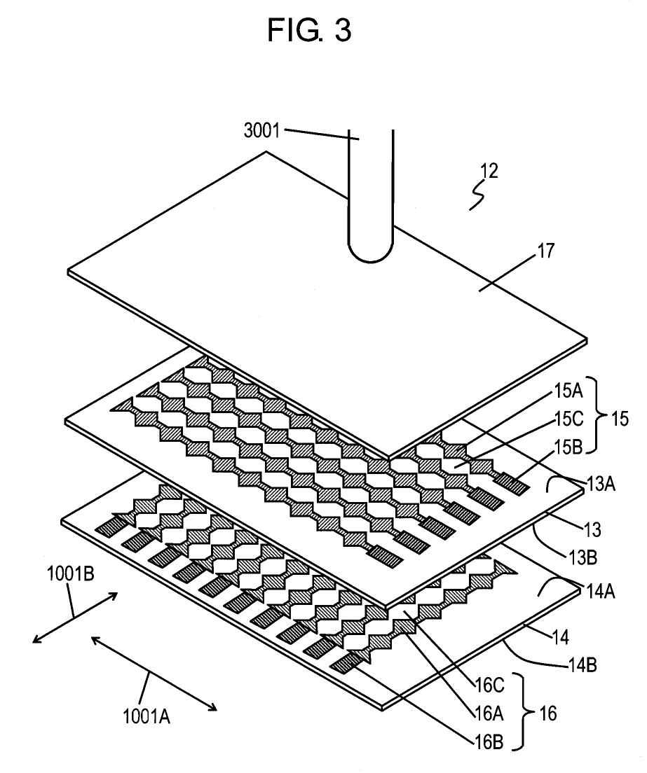

FIGS. 1 and 2A are a cross sectional view and a perspective view of a remote controller 1001 according to an exemplary embodiment of the present invention, respectively. In the figures, the remote controller 1001 is illustrated being enlarged in its thickness direction for easy understanding. A case 11 has substantially a box shape made of insulating resin material, such as polystyrene or ABS. A capacitive touch panel 12 is fitted into an opening provided in an upper surface of the case 11.

FIG. 2B is a schematic view of the remote controller 1001 and an apparatus 2001, such as a television receiver, to be remotely controlled with the remote controller 1001. The apparatus 2001 includes a receiver 2001A for receiving a remote control signal from the remote controller 1001 and a display screen 30 of a display, such as a liquid crystal display.

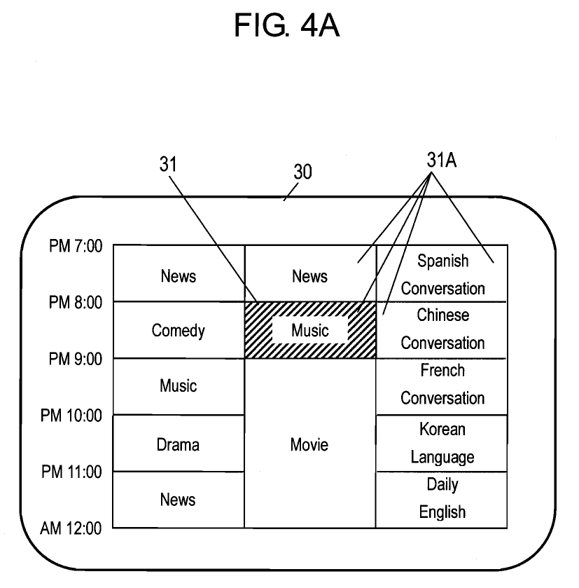

FIG. 3 is an exploded perspective view of the capacitive touch panel 12. As shown in FIGS. 1 and 3, the capacitive touch panel 12 includes an upper sheet 13, a lower sheet 14, plural upper conductive layers 15, plural lower conductive layers 16, and a cover sheet 17. The upper sheet 13, the lower sheet 14, the upper conductive layers 15, the lower conductive layers 16, and the cover sheet 17 are flexible, thus providing the capacitive touch panel 12 with flexibility. The upper sheet 13 and the lower sheet 14 are made from insulating flexible films made of electrically insulating resin, such as polyethylene terephthalate. The upper conductive layers 15 and the lower conductive layers 16 are patterned on an upper surface 13A and a lower surface 13B of the upper sheet 13, respectively. Lower surfaces 115B of the upper conductive layers 15 are situated on the upper surface 13A of the upper sheet 13. Upper surfaces 116A of the lower conductive layers 16 are situated on the lower surface 13B of the upper sheet 13. The lower surfaces 116B of the lower conductive layers 16 are situated on the upper surface 14A of the lower sheet 14. Each of the upper conductive layers 15 includes plural conductors 15A having substantially square shapes. The conductors 15A are arranged along a straight line in a direction 1001A and coupled to each other. Each of the lower conductive layers 16 includes plural conductors 16A having substantially square shapes. The conductors 16A are arranged along a straight line in a direction 1001B perpendicular to the direction 101A, and coupled to each other. The upper conductive layers 15 and the lower conductive layers 16 are made of conductive material, such as silver or carbon. Each of the upper conductive layers 15 has an electrode 15B provided at an end thereof. Each of the lower conductive layers 16 has an electrode 16B provided at an end thereof. Each of spaces 15C is surrounded by the conductors 15A on the upper surface 13A of the upper sheet 13. Each of spaces 16C is surrounded by the conductors 16A and between the lower surface 13B of the upper sheet 13 and the upper surface 14A of the lower sheet 14. The conductors 15A and the spaces 15C are arranged alternately. The conductors 16A and the spaces 16C are arranged alternately. The conductor 15A faces the space 16C across the upper sheet 13. The conductor 16A faces the space 15C across the upper sheet 13. The cover sheet 17 is made of insulating film and bonded with an adhesive, such as acrylic or rubber adhesive, to the upper surfaces 115A of the upper conductive layers 15, thus providing the capacitive touch panel 12. The capacitive touch panel 12 has an upper surface 12A and a lower surface 12B. The upper surface 12A is the upper surface 17A of the cover sheet 17 while the lower surface 12B is the lower surface 14B of the lower sheet 14.

A circuit board 18 made of insulating material, such as paper phenol or glass epoxy, has an upper surface 18A thereof facing the capacitive touch panel 12. Wiring patterns made of conductive material, such as copper foil, is provided on the upper surface 18A and the lower surface 18B of the circuit board 18. Stationary contacts 19 are provided on the upper surface 18A of the circuit board 18. Each of stationary contacts 19 includes a center stationary contact 19A having substantially a circular shape and an outer stationary contact 19B having of substantially a horse-shoe shape surrounding the center stationary contact 19A. The stationary contacts 19 are made of conductive material, such as copper or carbon.

A base sheet 20 is made of flexible insulating film, such as polyethylene terephthalate, polycarbonate, or polyurethane. Each of movable contacts 21 has substantially a dome shape and made of thin metal plate, such as a copper alloy plate or a steel plate. The movable contact 21 has a convex surface 21A, a concave surface 21B opposite to the convex surface 21A, and an outer edge 2C. The convex surface 21A of movable contact 21 is bonded onto a lower surface 120B of the base sheet 20. The outer edge 21C of the movable contact 21 is placed on the outer stationary contact 19B. The lower surface 120B of the base sheet 20 is bonded onto the upper surface 18A of the circuit board 18 so that the concave surface 21B of the movable contact 21 is spaced by a distance from the center stationary contact 19A. The movable contact 21 and the stationary contact 19, that is, the movable contact 21, the center stationary contact 19A, and the outer stationary contact 19B constitute a push switch 22.

Projections 20A made of resin material, such as polyester or epoxy resin, are provided on the upper surface 120A of the base sheet 20. The projections 20A has lower surfaces 220B situated on the upper surface 120A of the base sheet 20. Each of the projections 20A faces the convex surface 21A of the movable contact 21 across the base sheet 20. Upper surfaces 220A of the projections 20A contact the lower surface 12B of the capacitive touch panel 12, i.e., the lower surface 14B of the lower sheet 14.

As shown in FIGS. 1 and 2A, the stationary contacts 19 and the movable contacts 21, i.e., the push switches 22 are provided at different places beneath the capacitive touch panel 12. According to this embodiment, the five push switches 22 are arranged in a cross pattern having a center and peripheries surrounding the center of the capacitive touch panel 12.

A transmitter 23 including an electronic device, such as a light emitting diode, for transmitting remote-control signals and a control unit 24, such as a microcomputer, are mounted onto the circuit board 18. Push buttons 25 are mounted to the case 11. The push buttons are activated upon being when depressed or tilted. Push switches are provided beneath the push buttons 25 and electrically activated in response to operations to the push buttons 25.

The push switches beneath the push buttons 25, the transmitter 23, the stationary contacts 19, and the electrodes 15B and 16B of the capacitive touch panel 12 are electrically connected via the wiring patterns provided on the circuit board 18 to the control unit 24 and a power supply. The case 11 is covered with a cover 26, thus providing the remote controller 1001.

An operation of the remote controller 1001 will be described below.

When the push button 25 is depressed or tilted with a finger while the remote controller 1001 is directed towards the apparatus 2001 shown in FIG. 2B, the push switch beneath the push button is electrically activated. In response to the electrical activation, the control unit 24 directs the transmitter 23 to transmit a remote-control signal in wireless form, such as an infrared ray signal, to the apparatus 2001. Upon receiving the remote-control signal, the receiver 2001A performs operations to the apparatus 2001, such as turning on and off, or increasing and decreasing of the volume of sound.

The control unit 24 supplies predetermined currents selectively and sequentially to the upper conductive layers 15 via the electrodes 15B and supplies predetermined currents selectively to the lower conductive layers 16 via the electrodes 16B. When the upper surface 12A of the capacitive touch panel 12 (the upper surface 17A of the cover sheet 17) is touched with a operation body 3001 (FIG. 2A), such as a finger of an operator or a dedicated touch pen, a static capacitance between upper conductive layer 15 and lower conductive layer 16 at or near a position touched with the operation body 3001 changes locally. Accordingly, the electric potentials of upper conductive layer 15 and lower conductive layer 16 at or near the position touched with the operation body 3001 changes. The control unit 24 identifies the touched position based on the change of the potentials. Thus, the control unit 24 detects touched positions of the upper surface 12A of the capacitive touch panel 12 which are located continuously. Controller 24 may supply the currents to upper electrodes 15 and lower electrodes 16 simultaneously to detect the positions.

Upon being pressed down with the operation body 3001, the capacitive touch panel 12 sags downward and urges the projection 20A of the lower surface 12B (14B) to push the movable contact 21 across the base sheet 20. This operation causes the movable contact 21 to elastically deform and to have the concave surface 21B contact the center stationary contact 19A. Then, the movable contact 21 connects the center stationary contact 19A electrically to the outer stationary contact 19B, thus activating and turning on the push switch 22. The control unit 24 detects the activation of the push switch 22 by detecting the electrical connection between the stationary contacts 19A and 19B, and transmits a remote-control signal indicating the activation of the push switch 22 from the transmitter 23 to the apparatus 2001.

That is, the capacitive touch panel 12 has the upper surface 12A arranged to be pressed and the lower surface 12B, and has flexibility. The push switches 22 are provided beneath the lower surface 12B of the capacitive touch panel 12, and are activated upon being pressed via the capacitive touch panel 12. The controller 24 detects a position on the upper surface 12A of the capacitive touch panel 12 which is touched. The transmitter 23 transmits a first remote-control signal indicating the pressed position and a second remote-control signal corresponding the activating of the push switches 22.

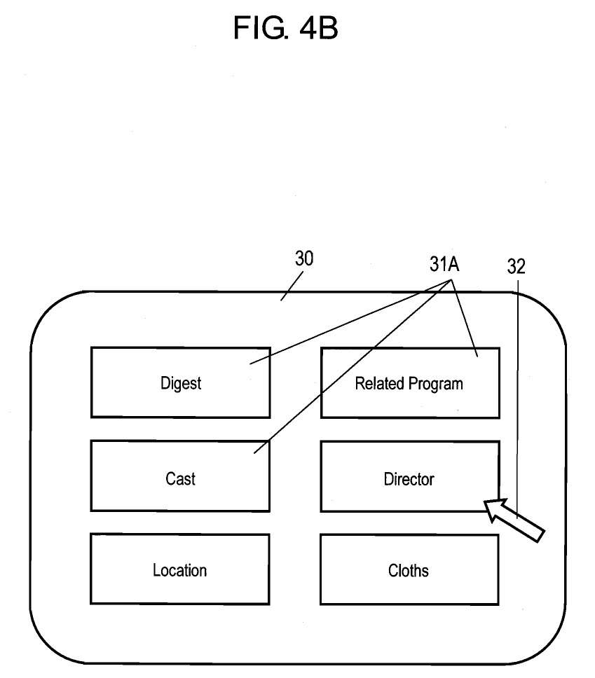

FIG. 4A illustrates the display screen 30 of the apparatus 2001 displaying television broadcast programs. The display screen 30 displays options 31A, i.e., the programs, and an indicator 31, such as a cursor, indicating a selected position. When an operator touches the upper surface 12A of the capacitive touch panel 12 with the operation body, such as a finger or a dedicated touch pen, the control unit 24 detects the touched position by the above method. The operator moves the operation body 3001 on the upper surface 12A, and the control unit 24 detects the movement and calculates a direction and a distance of the movement of the operation body. The control unit 24 then directs the transmitter 23 to transmit a remote-control signal indicating the direction and distance of the movement to the apparatus 2001. Upon the receiver 2001A receiving the remote-control signal, the apparatus 2001 moves the indicator 31 in a direction corresponding to the direction of the movement of the operation body on the display screen 30. For example, the operator moves the operation body 3001 upward on the upper surface 12A of the capacitive touch panel 12, the control unit 24 transmits a remote-control signal from the transmitter 23 to the apparatus 2001, and the indicator 31 displayed on the display screen 30 moves upward according to the remote-control signal. The operator moves the operation body 3001 on the upper surface 12A to position the indicator 31 on the display screen 30 at an option out of the options 31A to be selected, and presses the capacitive touch panel 12 with the operation body 3001 to activate and turn on the push switch 22. The control unit 24 detects the activation of the push switch 22 by the electrical connection between the stationary contacts 19A and 19B, and transmits the signal indicating of the activation of the push switch 22 from the transmitter 23 to the apparatus 2001 to fix the selected option out of the options 31A.

FIG. 4B illustrates the display screen 30 displaying a profile of a television program. As the operator moves the operation body 3001 on the upper surface 12A of the capacitive touch panel 12 rightward, the control unit 24 transmits a remote-control signal from the transmitter 23 to the apparatus 2001. According to the remote-control signal, the apparatus 2001 moves an indicator 32, a pointer displayed on the display screen 30. After moving the indicator 32, the operator presses the capacitive touch panel 12 with the operation body 3001 to activate and turn on the push switch 22 located at a right position. The control unit 24 transmits a remote-control signal indicating the activation of the push switch 22 from the transmitter 23 to the apparatus 2001. Upon the receiver 2001A receiving the remote-control signal, the apparatus 2001 fixes a selected option out of options 31A.

The operator may move the indicators 31 and 32 excessively in a desired direction, such as upward or rightward direction, while selecting an option out of the options 31A. In that case, the remote controller 1001 according to this embodiment does not require the operator to remove the operation body 3001 from the capacitive touch panel 12 and confirm a position to be pressed, but allows the operator to move back the operation body 3001 in a direction reverse to the desired direction while monitoring the display screen 30 to select one of the options 31A easily. Thus, the remote controller 1001 according to this embodiment allows the operator to perform various remote operations of the apparatus 2001 easily by simple operations.

In the remote controller 1001, the control unit 24 transmits the same remote-control signal from the transmitter 23 to the apparatus 2001 in response to the activation of each of the push switches 22. Alternatively, the control unit 24 of the remote controller 1001 may transmit different remote-control signals from the transmitter 23 in response to the activation of the push switches 22. This operation allows the apparatus 2001 to performing the other remote-control operations, for example, to move the indicator 31 and 32 quickly in a desired direction.

The push switches 22 are arranged in the cross pattern at the center, upper, lower, left, and right positions of the capacitive touch panel 12. This arrangement allows the operator to presses the push switches 22 reliably with preferable operation feeling.

In the above description, terms, such as “upper surface”, “lower surface”, and “downward”, representing directions do not represent absolute directions, such as a vertical direction, but do represent relative directions depending on the position of components of the remote controller 1001.

What is claimed is:

1. A remote controller comprising:
a capacitive touch panel having an upper surface and a lower surface, the capacitive touch panel having flexibility, the upper surface of capacitive touch panel being arranged to be pressed;
a plurality of push switches provided beneath the lower surface of the capacitive touch panel, the plurality of push switches being activated upon being pressed via the capacitive touch panel;
a control unit for detecting a position on the upper surface of the capacitive touch panel which is touched; and
a transmitter for transmitting a first remote-control signal indicating the detected position and a second remote-control signal indicating the activating of the plurality of push switches.

2. The remote controller according to claim 1, wherein the plurality of push switches are arranged substantially in a cross pattern beneath the lower surface of the capacitive touch panel.
